(19) United States
(12) Patent Application Publication
(10) Pub. No.: US 2011/0273131 A1
(43) Pub. Date: Nov. 10, 2011

(54) FUEL CELL SYSTEM AND DRIVING METHOD THEREOF

(75) Inventors: Seong-Kee YOON, Yongin-si (KR); Young-Jae KIM, Yongin-si (KR); Jung-Kurn PARK, Yongin-si (KR); Iei HU, Yongin-city (KR); Hye-Jung CHO, Yongin-city (KR); In-Seob SONG, Yongin-si (KR)

(73) Assignee: SAMSUNG SDI CO., LTD. (SDI), Yongin-si (KR)

(21) Appl. No.: 12/974,909

(22) Filed: Dec. 21, 2010

(30) Foreign Application Priority Data
May 4, 2010 (KR) 10-2010-0042119

(51) Int. Cl. H01M 10/46

(52) U.S. Cl. 320/101

(57) ABSTRACT

A driving method of a fuel cell system, which includes a secondary battery and a fuel cell stack, is disclosed. The method includes detecting a state of charge (SOC) of the secondary battery, driving the fuel cell stack to an on-state whenever the SOC of the secondary battery is less than a predetermined first SOC, and driving the fuel cell stack to an off-state whenever the SOC of the secondary battery is greater than a predetermined second SOC. In this method, the fuel cell stack is driven at a fuel concentration having optimum efficiency, thereby increasing the fuel efficiency of the fuel cell system.

### CLAIM OF PRIORITY

This application makes reference to, incorporates the same herein, and claims all benefits accruing under 35 U.S.C. §119 from an application earlier filed in the Korean Intellectual Property Office on 4 May 2010 and there duly assigned Serial No. 10-2010-0042119.

### BACKGROUND OF THE INVENTION

1. Field of the Invention

The present invention relates to a fuel cell system and a driving method thereof. More particularly, the present invention relates to a direct methanol fuel cell system for improving fuel efficiency and a driving method thereof.

2. Description of the Related Art

A fuel cell is a power generation system that generates electric energy through electrochemical reaction between hydrogen contained in hydrocarbon-based material such as methanol, ethanol, and natural gas and oxygen from air.

Fuel cells can be classified as phosphoric acid fuel cells (PAFC), molten carbonate fuel cells (MCFS), solid oxide fuel cells (SOFC), polymer electrolyte membrane fuel cells (PEMFC), alkaline fuel cells (AFC), etc. depending on the type of electrolyte used. These respective fuel cells operate on the same basic principle, but differ in the types of fuels used, operating temperatures, catalysts, electrolytes, etc.

Since a polymer electrolyte membrane fuel cell (PEMFC) uses an ion-exchange membrane made of a solid polymer as an electrolyte, the PEMFC has no risk of corrosion or evaporation caused by the electrolyte. The polymer electrolyte membrane fuel cell has high output density and high energy transformation efficiency, and is operable at a low temperature of 80° C. or less. In addition, the polymer electrolyte membrane fuel cell can be miniaturized and sealed and thus it has been widely used as a power source for a variety of applications such as for a pollution-free vehicle, home power equipment, mobile communication equipment, military equipment, medical equipment, and the like.

Moreover, a fuel cell that uses an ion-exchange membrane made of a solid polymer as an electrolyte includes a direct methanol fuel cell (DMFC). The direct methanol fuel cell is similar to the polymer electrolyte membrane fuel cell, but is able to supply a liquid-phase methanol fuel directly to a stack. Since the direct methanol fuel cell does not use a reformer for obtaining hydrogen from fuel, unlike the polymer electrolyte methanol fuel cell, but directly uses a liquid-phase fuel and is operable at a temperature below 100° C. the direct methanol fuel cell is more suitable as a power source for a small-sized electronic device or a power source for a portable electronic device.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a fuel cell system capable of increasing fuel efficiency and a driving method thereof.

An exemplary embodiment of the present invention provides a driving method of a fuel cell system, which includes a secondary battery and a fuel cell stack. The method includes detecting a state of charge (SOC) of the secondary battery, driving the fuel cell stack to an on-state whenever the SOC of the secondary battery is less than a first SOC, and driving the fuel cell stack to an off-state whenever the SOC of the secondary battery is greater than a second SOC.

The secondary battery may be charged with electric current generated from the fuel cell stack if the SOC of the secondary battery is less than the first SOC.

The fuel cell stack may be turned off if the SOC of the secondary battery is greater than the second SOC.

The fuel cell system may be coupled to a load unit and an electric energy may be supplied to the load unit from the fuel cell system. The electric energy may be supplied only from the secondary battery if a load of the load unit is less than a nominal power.

The fuel cell stack may generate electric current corresponding to a nominal power.

The electric current generated by the fuel cell stack may be supplied to the secondary battery to charge the secondary battery if the load of the load unit is less than a nominal power.

A fuel of the fuel cell stack may include methanol.

Another exemplary embodiment of the present invention provides a driving method of a fuel cell system, which includes a secondary battery and a fuel cell stack. The fuel cell system is coupled to a load unit and an electric energy is supplied to the load unit from the fuel cell system. The method includes maintaining the fuel cell stack in an off-state if a load of the load unit is less than a nominal power of the fuel cell stack, detecting a state of charge (SOC) of the secondary battery, and driving the fuel cell stack to an on-state if the SOC of the secondary battery is less than a first SOC.

The method may further include driving the fuel cell stack to an off-state if the SOC of the secondary battery is greater than a second SOC.

The second battery may be charged with electric energy generated by the fuel cell stack.

The fuel cell stack may generate electric current corresponding to the nominal power.

A fuel having a predetermined concentration and an oxidant may be supplied to the fuel cell stack. The fuel may include methanol having a predetermined concentration.

Still another exemplary embodiment the present invention provides a fuel cell system including a fuel cell stack including a plurality of unit cells, a secondary battery electrically connected to the fuel cell stack, and a controller coupled to the fuel cell stack and the secondary battery. Each of the unit cells includes a membrane-electrode assembly and separators disposed on both sides of the membrane-electrode assembly. The membrane-electrode assembly includes a cathode, an anode, and an electrolyte membrane disposed between the cathode and the anode. The secondary battery is charged with electric energy generated by the fuel cell stack. The controller detects a state of charge (SOC) of the secondary battery. The controller drives the fuel cell stack to an on-state whenever the SOC of the secondary battery is less than a first SOC. The controller drives the fuel cell stack to an off-state whenever the SOC of the secondary battery is greater than a second SOC.

The fuel cell system may further include a fuel supply unit for supplying fuel to the fuel cell stack.

The fuel cell system may further include a fuel mixing unit for mixing the fuel supplied from the fuel supply unit with unreacted fuel recovered from the fuel cell stack to make the mixed fuel of the fuel mixing unit have a predetermined concentration.

The predetermined concentration may be a concentration, with which the fuel cell stack generates electric current corresponding to a nominal power of the fuel cell stack.

The fuel supplied from the fuel supply unit and the unreacted fuel recovered from the fuel cell stack may include methanol.

The fuel cell system may be coupled to a load unit and an electric energy is supplied to the load unit from the fuel cell system. The controller detects the SOC of the secondary battery only if a load of the load unit is less than a nominal power of the fuel cell stack.

The fuel cell stack is driven at a fuel concentration having optimum efficiency, thereby increasing the fuel efficiency of the fuel cell system.

Moreover, the balance of plant does not need to be controlled in real time because the fuel cell stack is operated so as to generate current having a constant magnitude, and accordingly the fuel cell system can be stably driven. Power consumption of the balance of plant can be decreased because the balance of plant is fixedly operated at an optimum condition in accordance with the conditions of the fuel cell stack.

High fuel efficiency can be attained over a wide power range because the fuel cell stack can be operated at an optimum condition all the time even under a load lower than the nominal power of the fuel cell system.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram schematically showing the configuration of a fuel cell system according to one exemplary embodiment of the present invention.

FIG. 2 is a flowchart showing a driving method of the fuel cell system according to one exemplary embodiment of the present invention.

FIG. 3 is a graph showing a result of a driving experiment of the fuel cell system according to one exemplary embodiment of the present invention.

FIG. 4 is a graph showing a result of a driving experiment of a fuel cell system according to another exemplary embodiment of the present invention.

### DETAILED DESCRIPTION OF THE INVENTION

A fuel cell is a power generation system that generates electric energy through electrochemical reaction between hydrogen contained in hydrocarbon-based material such as methanol, ethanol, and natural gas and oxygen from air. Fuel cells can be classified as phosphoric acid fuel cells (PAFC), molten carbonate fuel cells (MCFS), solid oxide fuel cells (SOFC), polymer electrolyte membrane fuel cells (PEMFC), alkaline fuel cells (AFC), etc. depending on the type of electrolyte used. These respective fuel cells operate on the same basic principle, but differ in the types of fuels used, operating temperatures, catalysts, electrolytes, etc. Since a polymer electrolyte membrane fuel cell (PEMFC) uses an ion-exchange membrane made of a solid polymer as an electrolyte, the PEMFC has no risk of corrosion or evaporation caused by the electrolyte. The polymer electrolyte membrane fuel cell has high output density and high energy transformation efficiency, and is operable at a low temperature of 80° C. or less. In addition, the polymer electrolyte membrane fuel cell can be miniaturized and sealed and thus it has been widely used as a power source for a variety of applications such as for a pollution-free vehicle, home power equipment, mobile communication equipment, military equipment, medical equipment, and the like.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

For various exemplary embodiments, constituent elements having the same constitution are designated with the same reference numerals and explained representatively in the first exemplary embodiment. In other exemplary embodiments, only constituent elements that are different from those in the first exemplary embodiment are described.

In order to clarify the present invention, parts that are not related to descriptions are omitted, and the same or similar elements are given the same reference numerals throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the words “comprise” and “include” and variations such as “comprises”, “comprising”, “includes”, or “including” will be understood to imply the inclusion of stated elements but not the exclusion of any other elements.

The direct methanol fuel cell includes a fuel cell stack, a fuel tank, a fuel pump, an oxidant pump, etc. The fuel cell stack generates electric energy by electrochemically reacting fuel containing hydrogen with an oxidant such as oxygen or air. The fuel cell stack has a stack structure in which a plurality of unit fuel cells, each including a membrane-electrode assembly (MEA) and separators, are stacked. The membrane-electrode assembly has a structure where an anode, to which fuel is fed, and a cathode, to which an oxidant is fed, are attached to each other, with a polymer electrolyte membrane interposed therebetween.

A load is electrically connected to positive (+) and negative (−) terminals of the fuel cell stack so as to consume the electric energy generated by the fuel cell stack. Operating conditions of the fuel cell stack vary according to load requirements. In the case where the fuel cell stack is operated under different operating conditions according to load, the fuel efficiency of the fuel cell system may be decreased. This is because the fuel cell stack has optimum efficiency at a predetermined fuel concentration depending on its configuration and characteristics. For example, if the molar concentration of the fuel supplied to the anode is high, the amount of fuel passing from the anode to the cathode increases due to a limitation of the polymer electrolyte membrane, and a counter electromotive force is generated due to the fuel reacted at the cathode, thereby decreasing the output of the fuel cell stack. That is, even though an amount of the fuel supplied to the fuel cell stack increases, the output is not increased but rather decreased, thereby lowering the fuel efficiency of the fuel cell system.

Moreover, as the operating conditions of the fuel cell stack vary according to load requirements, the magnitude of electric current generated by the fuel cell stack varies. Accordingly, the operating conditions of the balance of plant (BOP), such as a fuel pump or an oxidant pump, vary. It is necessary to continuously control the operating conditions of the balance of plant according to the magnitude of electric current generated by the fuel cell stack. In the case of real time control of the balance of plant, there may be a problem in the stability of the fuel cell system. Further, if the balance of plant is driven more than necessary, this increases unnecessary power consumption and thus decreases the fuel efficiency of the fuel cell system.

In addition, a water recovery device, a heat exchanger, etc have to be operated all the time for the operation of the fuel cell system regardless of the magnitude of the current generated by the fuel cell stack. Even if the current generated by the fuel cell stack is low, the basic power consumption of the balance of plant is high, thus decreasing the fuel efficiency of the fuel cell system.

There is a need for a method of increasing the fuel efficiency of the fuel cell system.

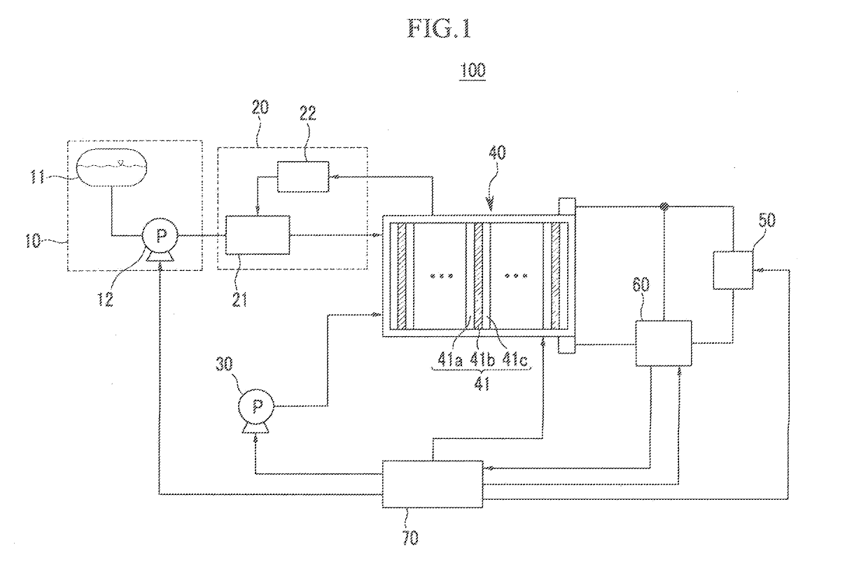

FIG. 1 is a block diagram schematically showing the configuration of a fuel cell system according to one exemplary embodiment of the present invention.

Referring to FIG. 1, a fuel battery system 100 may employ a direct methanol fuel cell (DMFC) that uses an ion exchange membrane made of a solid polymer as an electrolyte, and directly supplies a methanol fuel to a fuel cell stack to generate electric energy.

However, the present invention is not limited thereto, the fuel cell system 100 according to the exemplary embodiment of the present invention may employ a polymer electrolyte membrane fuel cell (PEMFC) that generates hydrogen by reforming a fuel and generates electric energy through an electrochemical reaction between oxygen and hydrogen. Furthermore, the fuel cell system 100 according to the exemplary embodiment of the present invention may be applied to various fuel cells such as a phosphoric acid fuel cell, a molten carbonate fuel cell, a solid oxide fuel cell, and an alkaline fuel cell.

The fuel cell system 100 includes a fuel supply unit 10, a fuel mixing unit 20, an oxidant supply unit 30, a fuel cell stack 40, a secondary battery 60, and a controller 70. The fuel cell system 100 is coupled to a load unit 50.

The fuel supply unit 10 supplies fuel to the fuel cell stack 40. The fuel supply unit 10 includes a fuel tank 11 and a fuel pump 12. In the fuel cell system 100 employing a direct methanol fuel cell scheme, methanol is stored in the fuel tank 11. In accordance with the configuration of the fuel cell system 100, a hydrocarbon-based fuel that is in a liquid-phase or gas-phase such as methanol, ethanol, natural gas, LPG, and the like may be stored in the fuel tank 11. The fuel pump 12 is connected to the fuel tank 11, and supplies the fuel stored in the fuel tank 11 from the fuel tank 11 to the fuel cell stack 40 with a predetermined pumping power.

The fuel mixing unit 20 mixes a high concentration fuel supplied from the fuel supply unit 10 with unreacted fuel recovered from the fuel cell stack 40. The fuel mixing unit 20 includes a fuel mixer 21 and a fuel recovery unit 22. The fuel mixer 21 is connected to the fuel tank 11 and the fuel recovery unit 22, and mixes the high concentration fuel stored in the fuel tank 11 with the unreacted fuel recovered from the fuel recovery unit 22. The fuel recovery unit 22 recovers the unreacted fuel by cooling or condensing discharge components discharged from the fuel cell stack 40. The fuel mixed at a predetermined concentration in the fuel mixing unit 20 is supplied to the fuel cell stack 40.

The oxidant supply unit 30 supplies an oxidant to the fuel cell stack 40. The oxidant supply unit 30 includes an oxidant pump. The oxidant pump sucks outside air with a predetermined pumping power.

The fuel cell stack 40 includes a plurality of unit cells for generating electric energy by inducing an oxidation-reduction reaction between the fuel and the oxidant. Each of the unit cells includes a membrane-electrode assembly 41b for oxidizing/reducing oxygen in the fuel and the oxidant, and separators (also referred to as bipolar plates) 41a and 41c for supplying the oxidant to the membrane-electrode assembly 41b. The unit cell 41 has a structure in which the separators 41a and 41c are disposed on both sides thereof with the membrane-electrode assembly 41b disposed at the center. The membrane-electrode assembly 41b includes an electrolyte membrane disposed at its center, a cathode disposed on one side of the electrolyte membrane, and an anode disposed on the other side of the electrolyte membrane. The oxidant is supplied to the cathode through the separators 41a and 41c, and the fuel is supplied to the anode. The fuel cell system 100 of the present invention includes the fuel cell stack 40 having the above-mentioned unit cells 41 consecutively arranged.

The load unit 50 is electrically connected to positive (+) and negative (−) terminals of the fuel cell stack 40 and to the secondary battery 60 of the fuel cell system 100. The load unit 50 consumes electric energy generated by the fuel cell stack 40 and the electric energy discharged from the secondary battery 60. The load unit 50 may include a variety of electric devices such as a motor for a vehicle, an inverter for converting a direct current into an alternating current, or a home electric heating device.

The secondary battery 60 is electrically connected to the positive (+) and negative (−) terminals of the fuel cell stack 40, and is electrically coupled to the load unit 50. The secondary battery 60 is charged with electric energy generated by the fuel cell stack 40, and the charged electric energy is consumed in the load unit 50. As the secondary battery 60, a lead storage battery that uses peroxide lead as the anode, lead as the cathode, and sulfuric acid as the electrolyte, an alkaline storage battery that uses nickel hydroxide as the anode, cadmium as the cathode, and an alkaline solution as the electrolyte, or the like can be employed.

The controller 70 controls the operations of the fuel supply unit 10, the oxidant supply unit 30, the fuel cell stack 40, and the secondary battery 60. The controller 70 is also coupled to the load unit 50, and detects a load applied to the load unit 50. The load of the load unit 50 is power that is required to properly operate the load unit 50. Specifically, the controller 70 controls the fuel cell stack 40 so that the fuel cell stack 40 always generates a current corresponding a nominal power. That is, the fuel cell stack 40 is driven in an off-state (turned off) or is driven to an on-state (turned on) for generating electric current corresponding to the nominal power. In the on-state, the fuel cell stack 40 supplies electric current to the load unit 50 or the secondary battery 60, and in the off-state, the fuel cell stack 40 does not supply electric current. The fuel cell stack 40 provides the best fuel efficiency when the fuel cell stack 40 generates electric current corresponding to the nominal power. In other words, the nominal power of the fuel cell stack 40 is an output power of the fuel cell stack 40, at which the fuel cell stack 40 has the best fuel efficiency. Herein, the fuel efficiency is a ratio of power outputted from the fuel cell stack 40 to the amount of fuel per hour that is consumed to generate the power.

To this end, the controller 70 controls the fuel pump 12 so that the fuel in the fuel mixer 21 maintains a constant concentration, i.e., a predetermined concentration required for the fuel cell stack 40 to generate the current corresponding to the nominal power. The fuel mixed at a constant concentration in the fuel mixer 21 is supplied to the fuel cell stack 40. The controller 70 controls the oxidant supply unit 30 so that the oxidant corresponding to the supplied fuel is supplied to the fuel cell stack 40.

The controller 70 controls the secondary battery 60 to supply electric energy charged in the secondary battery 60 to the load unit 50. The secondary battery 60 is able to output power higher than the nominal power. If the load of the load unit 50 is less than the nominal power, the controller 70 turns on the secondary battery 60 to supply the electric energy charged in the secondary battery 60 to the load unit 50. At this point, the controller 70 drives the fuel cell stack 40 to the off-state, or drives the fuel cell stack 40 to the on-state to charge the secondary battery 60 with the electric energy. If the load of the load unit 50 is greater than the nominal power, the controller 70 drives the fuel cell stack 40 to the on-state, and supplies electric energy generated from the fuel cell stack 40 and electric energy charged in the secondary battery 60 to the load unit 50.

If the fuel cell stack 40 is in the off-state and electric energy charged in the secondary battery 60 is supplied to the load unit 50, the controller 70 controls the on-state and off-state of the fuel cell stack 40 based on a state of charge (SOC) of the secondary battery 60. When the secondary battery 60 reaches a predetermined lower reference of SOC, the controller 70 drives the fuel cell stack 40 to the on-state, and the fuel cell stack 40 supplies electric energy to the load unit 50 and the secondary battery 60. The lower reference of SOC is referred to as a SOCL. When the secondary battery 60 reaches a predetermined upper reference of SOC, the controller 70 drives the fuel cell stack 40 to the off-state. The upper reference of SOC is referred to as a SOCH. That is, the controller 70 operates the fuel cell stack 40 in accordance with the charged state of the secondary battery 60, which may be represented by SOC of the secondary battery 60, regardless of the load required by the load unit 50. The SOCL is referred to as a first SOC, and the SOCH is referred to as a second SOC. Accordingly, if the SOC of the secondary battery 60 is less than the first SOC, the controller 70 drives the fuel cell stack 40 to the on-state. If the SOC of the secondary battery 40 is greater than the second SOC, the controller 70 drives the fuel cell stack 40 to the off-state. The controller 70 may detect the SOC of the secondary battery 60 only if a load of the load unit 50 is less than a nominal power of the fuel cell stack 40.

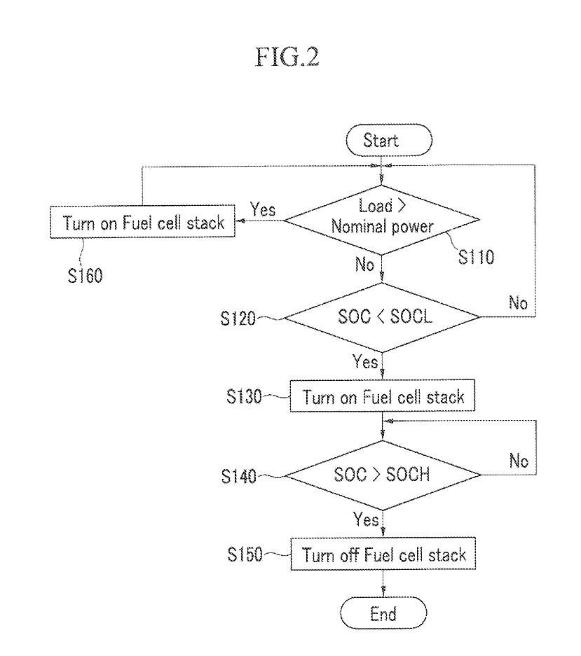

A driving method of the fuel cell system 100 in accordance with the charged state of the secondary battery 60 will be described in detail with reference to FIG. 2.

FIG. 2 is a flowchart showing a driving method of the fuel cell system according to one exemplary embodiment of the present invention.

Referring to FIG. 2, the controller 70 detects a load of the load unit 50, and determines whether the load is greater than a nominal power of the fuel cell stack 40 (S110). If the load is greater than the nominal power of the fuel cell stack 40, the controller 70 drives the fuel cell stack 30 to an on-state (S160). If the load of the load unit 50 is less than or equal to a nominal power or the load of the load unit 50 can be satisfied only by an output of the secondary battery 60, only the secondary battery 60 supplies electric energy to the load unit 50.

That is, if the load of the load unit 50 is below a predetermined threshold value, the fuel cell stack 40 is maintained in the off state and only the secondary battery 60 is driven to supply electric energy to the load unit 50. If the load of the load unit 50 is above the threshold value, the fuel cell stack 40 is driven to the on state, and electric energy is supplied to the load unit 50 from the fuel cell stack 40 together with the secondary battery 60. The threshold value of the load unit 50 can be determined based on the nominal power of the fuel cell stack 40 or by the maximum output of the secondary battery 60. In the example shown in FIG. 2, the threshold value is set to the nominal power.

For instance, the load basically consumed by the balance of plant (BOP) that has to be operated all the time for the operation of the fuel cell system 100 is less than the nominal power or the maximum output of the secondary battery 60. It is not desirable in terms of fuel efficiency to drive the fuel cell stack 40 for the load consumed by the balance of plant. Therefore, when the load of the load unit 50 is below the threshold value, the fuel cell stack 40 is maintained in the off state, and only the secondary battery 60 is driven to supply electric energy, thus increasing fuel efficiency.

The controller 70 detects a state of charge (SOC) of the secondary battery 60, and compares and determines whether the SOC of the secondary battery 60 is less than a SOCL (S120). The SOCL is a charged state that requires the charging of the secondary battery 60. For example, when the secondary battery 60 is in a fully charged state (100%), the SOCL can be set to 50%, which is a predetermined charged state, by taking the characteristics of the secondary battery 60 into account. If the charged state of the secondary battery 60 is not less than the SOCL, the controller 70 continuously detects the charged state of the secondary battery 60 and compares it with the SOCL.

If the charged state of the secondary battery 60 is less than the SOCL, the controller 70 drives the fuel cell stack 40 to the on state (S130). That is, a fuel having a predetermined concentration and an oxidant are supplied to the fuel cell stack 40 so that the fuel cell stack 40 generates electric current corresponding to a nominal power. The current generated by the fuel cell stack 40 is supplied to the load unit 50 and the secondary battery 60. The remaining electric energy, except the electric energy consumed by the load unit 50, charges the secondary battery 60.

The controller 70 detects a state of charge (SOC) of the secondary battery 60, and compares and determines whether the SOC of the secondary battery 60 is greater than an SOCH (S140). The SOCH is a charged state that is defined to stop the driving of the fuel cell stack 40 and to drive only the secondary battery 60. For example, when the secondary battery 60 is in the fully charged state (100%), the SUCH can be set to 70%, which is a predetermined charged state. If the charged state of the secondary battery 60 is not higher than the SUCH, the controller 70 continuously detects the charged state of the secondary battery 60 and compares it with the upper reference of SOC.

If the charged state of the secondary battery 60 is greater than the SUCH, the controller 70 makes the fuel cell stack 40 stayed in the off state (S150). That k, the supply of the fuel and oxidant to the fuel cell stack 40 is interrupted and generation of electric current from the fuel cell stack 40 is stopped. At this time, the electric energy charged in the secondary battery 60 is supplied to the load unit 50.

The SOCL is referred to as a first charge state or a first SOC, and the SUCH is referred to as a second charged state or a second SOC. The fuel cell system 100 refers the SOC of the secondary battery 60 and the predetermined first and second SOCs to control the driving of the fuel cell stack 40. The fuel cell system 100 detects the charged state of the secondary battery 60 and drives the fuel cell stack 40 so as to generate a current corresponding to a nominal power whenever the secondary battery 60 reaches the first charged state. The fuel cell system 100 stops the driving of the fuel cell stack 40 whenever the second battery 60 reaches the second charged state.

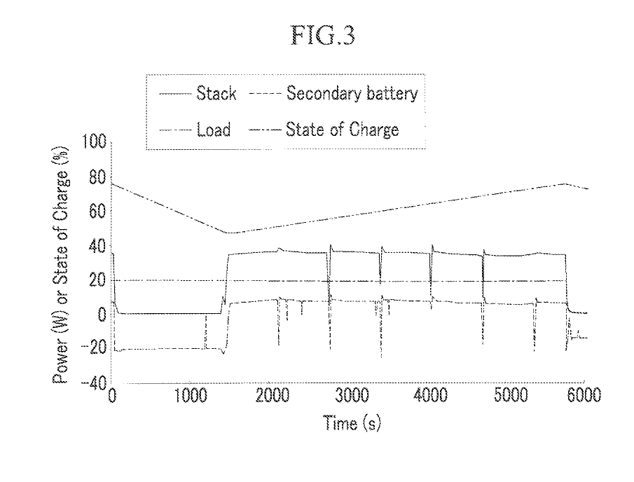

FIG. 3 is a graph showing a result of a driving experiment of the fuel cell system according to one exemplary embodiment of the present invention.

Referring to FIG. 3, an SOCH of the secondary battery was set to 75%, and a SOCL was set to 50%. The load of the load unit 50 was set to be maintained at 75% of a nominal power.

In FIG. 3, the unit of the vertical axis of the graph is State of Charge (%) or Power (W). In the legend of FIG. 3. Stack means output power from the fuel cell stack 40, Secondary battery means output power from the secondary battery 60, Load means the load of the load unit 50, and State of Charge means the SOC of the secondary battery 60. The unit of SOC is State of Charge (%), and the units of the Stack, Secondary battery and Load are Power (W). As shown in FIG. 3, the SOC first gradually decreased from 75% to 50% over time, and then increases up to 75%. While SOC decreases to 25%, the secondary battery is in the discharge state (at about −20 W), and the fuel cell stack outputs no power (about 0 W). While the SOC increases from 25% up to 75%, the output power of the fuel cell stack increases and the output power of the secondary battery also changes. The graph shown in FIG. 3 is an experimental result, and the upper and lower references of SOC may be set to different values.

It can be seen that as the secondary battery 60 supplies electric energy to the load unit 50, a state of charge (SOC) of the secondary battery gradually decreases over time, and if the SOC of the secondary battery 60 reaches the lower reference of SOC, the fuel cell stack 40 is driven to the on-state and charges the secondary battery 60. At this time, the fuel cell stack is driven so as to generate electric current corresponding to the nominal power.

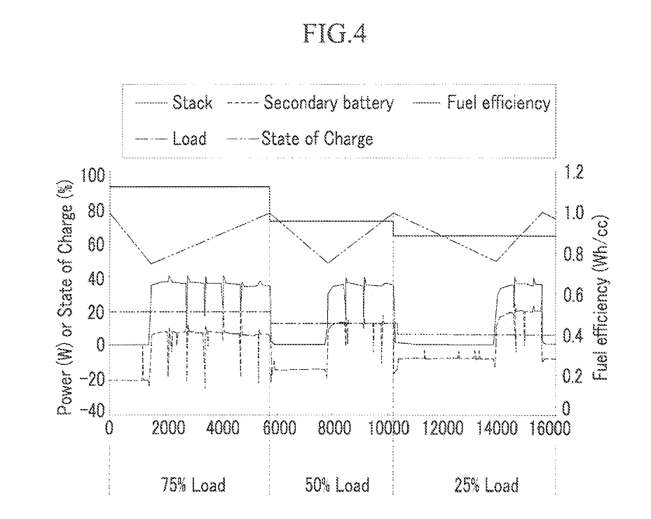

FIG. 4 is a graph showing a result of a driving experiment of a fuel cell system according to another exemplary embodiment of the present invention. The meanings of legends of FIG. 4 are the same as those of FIG. 3. FIG. 4 additionally shows a fuel efficiency.

Referring to FIG. 4, the fuel efficiency (Wh/cc) of the fuel cell stack was measured when an SOCH of the secondary battery was set to 75%, and a SOCL was set to 50%. The load of the load unit 50 was varied to 75%, 50%, and 20% of a nominal power. Herein, the fuel efficiency means how much power is outputted for consumption amount of fuel per hour. The higher fuel efficiency means that less fuel is required to output the same amount of energy.

FIG. 4 shows that the higher the load is, the larger amount of electric energy is consumed, and therefore the charging time of the secondary battery, in which the fuel cell stack is driven in the on state, becomes longer. Also, the time during which only the secondary battery is driven, i.e., the time during which the fuel cell stack is in the off state, becomes shorter. On the contrary, at the lower the load, the time, during which the fuel cell stack is driven in the on-state, becomes shorter, and the time, during which the fuel cell stack is in the off-state, becomes longer. It can be seen that, under a high load condition, the time, during which the fuel cell stack is driven in the on state, is long, resulting in better fuel efficiency compared to a low load condition.

As described above, the fuel cell stack is driven so as to generate electric current corresponding to a nominal power having optimum efficiency, thereby increasing the fuel efficiency of the fuel cell system. Moreover, the balance of plant does not need to be controlled in real time because the fuel cell stack is operated so as to generate current having a constant magnitude, and accordingly the fuel cell system can be stably driven. Furthermore, high fuel efficiency can be attained over a wide power range because the fuel cell stack can be operated at an optimum condition all the time even under a load lower than the nominal power.

The drawings referred to hereinabove and the detailed description of the disclosed invention are presented for illustrative purposes only, and not intended to define meanings or limit the scope of the present invention as set forth in the following claims. Those skilled in the art will understand that various modifications and equivalent other embodiments of the present invention are possible. Consequently, the true technical protective scope of the present invention must be determined based on the technical spirit of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a fuel cell system including a secondary battery and a fuel cell stack, the method comprising:
detecting a state of charge (SOC) of the secondary battery;
driving the fuel cell stack to an on-state whenever the SOC of the secondary battery is less than a first SOC; and
driving the fuel cell stack to an off-state whenever the SOC of the secondary battery is greater than a second SOC.

2. The method of claim 1, wherein the secondary battery is charged with electric current generated from the fuel cell stack if the SOC of the secondary battery is less than the first SOC.

3. The method of claim 2, wherein the fuel cell stack is turned off if the SOC of the secondary battery is greater than the second SOC.

4. The method of claim 1, wherein the fuel cell system is coupled to a load unit and an electric energy is supplied to the load unit from the fuel cell system, the electric energy being supplied only from the secondary battery if a load of the load unit is less than a nominal power.

5. The method of claim 4, wherein the electric current generated by the fuel cell stack is supplied to the secondary battery to charge the secondary battery if the load of the load unit is less than a nominal power.

6. The method of claim 1, wherein the fuel cell stack generates electric current corresponding to a nominal power.

7. The method of claim 1, wherein a fuel of the fuel cell stack includes methanol.

8. A driving method of a fuel cell system including a secondary battery and a fuel cell stack, the fuel cell system being coupled to a load unit and an electric energy being supplied to the load unit from the fuel cell system, the method comprising:
maintaining the fuel cell stack in an off-state if a load of the load unit is less than a nominal power of the fuel cell stack;
detecting a state of charge (SOC) of the secondary battery; and
driving the fuel cell stack to an on-state if the SOC of the secondary battery is less than a first SOC.

9. The method of claim 8, further comprising:
driving the fuel cell stack to an off-state if the SOC of the secondary battery is greater than a second SOC.

10. The method of claim 8, wherein the second battery is charged with electric energy generated by the fuel cell stack.

11. The method of claim 8, wherein the fuel cell stack generates electric current corresponding to the nominal power.

12. The method of claim 11, wherein a fuel having a predetermined concentration and an oxidant are supplied to the fuel cell stack.

13. The method of claim 12, wherein the fuel includes methanol having a predetermined concentration.

14. A fuel cell system comprising:
a fuel cell stack comprising a plurality of unit cells, each of the unit cells comprising:
a membrane-electrode assembly including a cathode, an anode, and an electrolyte membrane disposed between the cathode and the anode; and
separators disposed on both sides of the membrane-electrode assembly;
a secondary battery electrically connected to the fuel cell stack, the secondary battery being charged with electric energy generated by the fuel cell stack; and
a controller coupled to the fuel cell stack and the secondary battery, the controller detecting a state of charge (SOC) of the secondary battery, the controller driving the fuel cell stack to an on-state whenever the SOC of the secondary battery is less than a first SOC, the controller driving the fuel cell stack to an off-state whenever the SOC of the secondary battery is greater than a second SOC.

15. The fuel cell system of claim 14, further comprising a fuel supply unit for supplying a fuel to the fuel cell stack.

16. The fuel cell system of claim 15, further comprising a fuel mixing unit for mixing the fuel supplied from the fuel supply unit with unreacted fuel recovered from the fuel cell stack to make the mixed fuel of the fuel mixing unit have a predetermined concentration.

17. The fuel cell system of claim 16, wherein the predetermined concentration is a concentration, with which the fuel cell stack generates electric current corresponding to a nominal power of the fuel cell stack.

18. The fuel cell system of claim 16, wherein the fuel supplied from the fuel supply unit and the unreacted fuel recovered from the fuel cell stack include methanol.

19. The fuel cell system of claim 14, wherein the fuel cell system is coupled to a load unit and an electric energy is supplied to the load unit from the fuel cell system, the controller detecting the SOC of the secondary battery only if a load of the load unit is less than a nominal power of the fuel cell stack.
